(19) United States
(12) Patent Application Publication
(10) Pub. No.: US 2023/0405944 A1
(43) Pub. Date: Dec. 21, 2023

(54) MULTI-FUNCTIONAL AUTOMOTIVE FLOORING PART COMPRISING FIBERS FROM TEXTILE WASTE

(71) Applicant: AUTONEUM MANAGEMENT AG, Winterthur (CH)

(72) Inventor: Philippe GODANO, Winterthur (CH)

(73) Assignee: AUTONEUM MANAGEMENT AG, Winterthur (CH)

(21) Appl. No.: 18/247,944

(22) PCT Filed: Oct. 4, 2021
(86) PCT No.: PCT/EP2021/077227

§ 371 Date: Apr. 5, 2023

(30) Foreign Application Priority Data
Oct. 7, 2020 (EP) 20200646.6

(51) Int. Cl. B29C 70/30; B29C 70/34; B29C 70/12; B32B 5/26; B32B 27/12; B32B 3/30

(52) U.S. Cl. CPC B29C 70/305; B29C 70/34; B29C 70/12; B29L 2031/3017; B32B 27/12; B32B 3/30; B32B 5/26

(57) ABSTRACT

A main flooring part for a vehicle comprising an aesthetic surface layer and a spacer layer, whereby both layers are consolidated and laminated to the adjacent layer to form the flooring part, characterised in that both layers comprise pulled fibers from textile waste and a binder, and whereby the aesthetic surface layer is thermally compressed to form a stiff layer and whereby the fibers of the surface of the aesthetic surface layer are heat set to smooth the aesthetic surface.

This application is a national stage application under 35 U.S.C. 371 and claims the benefit of PCT Application No. PCT/EP2021/077227 having an international filing date of Oct. 4, 2021, which designated the United States, and which claimed the benefit of European Patent Application No. EP20200646.6, filed Oct. 7, 2020, the disclosures of each are incorporated by reference herein.

### TECHNICAL FIELD

The present invention is related to an automotive flooring part and a method of producing such a part.

### BACKGROUND ART

State of the art automotive flooring or main floor covering parts nearly always contains a layer masking the acoustical insulating and/or absorbing materials underneath, mostly a pile layer, like for instance a tufted carpet layer, however also rubber type or thermoplastic polyolefin (TPO) type materials are used. These type of layers are multilayer construction in themselves. Using such layers or constructions increases the complexity, the costs and in addition, reduces the sustainability footprint of the flooring system.

Another sustainability problem related to the flooring parts of the state of the art, is that the full layout of the part is present over the entire surface of the passenger compartment floor. This means that in many areas, the main floor part is over-engineered. The addition of floor mats, area covered by other appliances like seats, and/or placed on vertical walls all have an altered or reduced need; abrasion, stiffness and or acoustic requirements might be different. As the flooring system is designed with a one-fits-all approach, the highest requirements are taken for the full surface. Hence, more materials are used than necessary.

It becomes a main concern of the customer and the market in general that the resources and the processes we use are not sustainable. Sustainable in the sense of a circular economy as well as not increasing the ecological footprint during the process.

The objective of the present invention is to provide for a main flooring part for a vehicle and a method of producing such a part. In addition, more particular a main flooring part for a vehicle that forms a sustainable alternative to the current main flooring parts.

### SUMMARY OF INVENTION

In accordance with the present invention, there is provided a main floor part comprising an aesthetic layer and a spacer layer, whereby both layers are consolidated and laminated to the adjacent layer to form the flooring part and whereby both layers, the aesthetic layer and the spacer layer comprise pulled fibers from textile waste and a binder, and whereby the aesthetic surface layer is thermally compressed to form a stiff layer and whereby the fibers of the surface of the aesthetic surface layer are heat set to smooth the aesthetic surface.

Surprisingly, a layer comprising of pulled fibers from textile waste and a binder thermally compressed to form a stiff layer and to thermally smooth the fibers of the surface of the aesthetic layer against the mold is not only pleasing to the eye, but also sturdy enough to cover the full flooring. As the pulled fibers during a thermal process touch the mold surface they are heat set and at the same time slightly plasticized and bonded to the adjacent fibers, thereby creating a smoothed or ironed surface without any fibers sticking out. Due to the combination of compression molding and heat treatment it is possible to obtain a smooth surface that is easy to dry clean and initially rejects water droplets.

The heat setting process works like a surface ironing process. Whereby the outer surface of the aesthetic layer, visible to the passenger when the part is placed in the vehicle, is smooth by heat setting the fibers at the outer most surface of the layer. The heat setting can take place at the heating stage with contact heating in a cold molding process or at the 3D forming tool in hot molding process.

By using pulled fibers from the textile industry it is possible to recycle textiles made of cotton blended with synthetic materials, like polyester, polypropylene, polyamide or spandex. By incorporating them into the flooring part according to the invention a more sustainable solution is found for these types of waste streams.

Preferably the aesthetic surface layer is a thermally compressed air lay felt layer, pre-consolidated using needling.

Preferably the aesthetic surface layer has an area weight of between 500 and 3000 g/m2, preferably between 500 and 2000 g/m2. Preferably at a thickness of between 2 and 10 mm. As the minimal thickness of the layer is depending on the area weight, lower area weights will be able to obtain lower thickness, while for higher thicknesses more material is needed. The combination of air lay fibers, a pre-needling step, and final thermally compressing, preferably in a hot molding process, like a steam molding process, gives an even surface, with a smoothed surface finish, the molding tool “irons” the surface and slightly plasticizes the fibers on the top surface of the aesthetic surface during the thermal process. In addition the high compression enables a stiffer part, preventing any sinking in the part when standing on it as well as it prevents any damage of punctures by blunt objects like the heel of a shoe.

Surprisingly, the highly compressed smooth surface, in addition, prevents larger dirt particles from penetrating into the surface layer, hence vacuum cleaning is easier. However the still open surface layer is porous and accounting for a level of sound absorption, eliminating middle and/or high frequency noise. As there is no need for covering the largest part of the main flooring part, as is normally happening in state of the art parts, there is the advantage of an increased acoustic performance at reduced material weight and cost. Reducing weight is also important for making a vehicle more sustainable.

The spacer layer is either an injected fiber felt layer, a carded cross-lapped, or an air lay felt layer. The layer may be pre-consolidated to prevent falling apart during movement of the layer.

Whenever the word “consolidated” is used a process step is meant whereby the material is treated such that the fibers are held together and will not fall apart in single fibers, this may include a mechanical displacement of fibers like needling or a thermal bonding step. In case the material is pre-consolidated the material is held together but not fully bonded yet, like for instance a pre-needling step will give the material some hold during transport and will slightly compress the felt layer.

Both layers, the aesthetic surface layer and the spacer layer, comprise of pulled fibers from textile waste and a binder.

Based on the textile material used the pulled fibers might be at least one of cotton, polyester, polyamide, polypropylene, viscose, cellulose, for instance polyester fibers with a fiber fineness of between 1.7 to 17 dtex. The pulled fibers might be solid, hollow, or hollow conjugate fibers.

As the source of material might be a blend of materials, like for instance polyester/cotton, this might be taken into account as a possible source of already blended materials.

The source for the reclaimed fibers might be from household textiles or industrial fiber sources. Preferably at least part of the sourced material is coming from cut offs, scraps or discarded production from the automotive industry, for instance recycled carpets, fibrous automotive trim parts or layers for such trim parts, like spacer layers, decoupling layers or sound absorbing parts.

Another source of fibers, which do not necessarily need pulling in the classical sense, is reclaimed or recycled fibers from bedding and wadding, as these fibers are made of conjugate fibers they are permanent crimped and curled, and will even enhance the bulkiness of the initial fibrous layers as well as the final spacer layer produced with it. Preferably up to 30% of these types of fibers might be used in the spacer layer, to further enhance the bulkiness of this layer as well as the spring function.

Preferably, the aesthetic surface comprises pulled fibers from clean textile waste, to obtain an aesthetical pleasing surface and/or variety in the appearance of the surface, the fibers used might be selected as a specific color fraction or fractions of pulled fibers.

Preferably different blends of color fractions might be placed in the mold in a color gradient, as color blocks or stripes or any other random pattern. By using a randomized fiber filling into the tool of at least more than one color fraction blend, each floor surface will have its own pattern and unique signature. Alternatively dark colored fibers, preferably black or blue might be blended with a mixture of primary colors to obtain more contrasting patterns.

To further enhance the surface aesthetics an pattern might be embossed on the surface, for instance in the form of a leaf, check, raised circles etc. These embossment can be in the form of small raised areas in the surface, with a high of not more than 5 mm, preferably not more than 3 mm, such that they are visible but not interfering with the main functions of the floor part.

Preferably the main flooring part comprises pulled fibers with at least 80% of the pulled fibers being polyester based fibers and/or cotton based fibers and/or cellulose based fibers and/or a mixture thereof. The other % might be made of other materials like poly propylene, polyethylene, viscose or any other material that is considered a contamination of the main source of pulled fibers. Working cloth made of a blend of 50% polyester and 50% cotton would be preferable for main source of pulled fibers for the main flooring part according to the invention.

Preferably the binder is fiber or powder based, preferably from a recycled or reclaimed source, preferably pulled fiber based. The binder comprises at least one of a polymer or copolymer chosen from polyester, polyolefin, like polypropylene or polyethylene, or polyamide based materials. A preferred source of binder material might be textile waste coming from a product that used bicomponent fibers as a binder, for instance automotive trim part based on polyester. If needed bicomponent binder fibers from a recycled source might be used, preferably a coPET/PET binder (PET being polyethyleneterephthalate).

The final mixture of pulled fibers is depending on the sorting at the beginning of the recycling of the textile waste, but also on the quality of the material the textile waste was originally made with. Hence part of the material might be reduced in quality and/or will melt at a lower temperature than some of the other materials, however these lower melting fractions might be used as a binder or to enhance the binding properties within the surface layer.

For instance in a preferred embodiment, the flooring part according to the invention has an aesthetic surface comprising of between 30 and 70% by weight, preferably between 40 and 60% by weight of pulled fibers based on cotton and/or polyester, and whereby the binder is between 70 and 30% by weight of polypropylene pulled fibers, with a total amount of fibers and binder of 100% by weight.

Or for instance a combination of an air lay needled mat of around 800 to 1000 g/m2 is made from roughly 80% of pulled fibers of a blend of 50% polyester fibers and 50% cotton fibers, and 20% of binder based on a polymer or copolymer of polyester preferably fiber based.

If necessary fibers and/or binder fibers from other sources might be added to the pulled fiber blend to enhance certain features in the final layer, for instance bicomponent fibers, preferably spun from a recycled source of material, like bottle flakes, might be included to optimize the consolidation and/or stiffness of the surface or the spacer layer, preferably a combination of a polyester and a copolymer of polyester bicomponent fiber. Polyester fibers in black might also be added to the surface layer to obtain a certain aesthetic appearance.

To further enhance the aesthetic appearance of the aesthetic surface layer also other materials such as scrap textile material not fully pulled into fibers might be used mixed within the blend or scattered on top of the felt layer during or directly after the air lay process, but before the pre-needling step.

Also other materials like tread waste, or lurex, or metalized textile materials pulled into fibers or into small scraps, might be used to obtain a sparkling or coloring effect within the aesthetic surface layer.

Alternatively at least 2 air lay layers with different colors might be placed on top of each other and during the pre-needling part of the fibers of the one layer become visible on the surface of the other layer, as the needles pulls the fibers through the layers. For this step preferably barbed needles are used.

As the flooring part is not in addition covered with a decorative layer like a pile layer, the acoustic attenuation might be increased. In particularly as the basic 2 layer part with a stiffer top layer and a bulky less compressed spacer layer forms a dual layer sound absorbing part. The acoustic might also enhanced by including either air permeable film, a closed film or a mass layer between the surface layer and the spacer layer.

The air permeable film will boost the sound absorption while the closed film or the mass layer will enhance sound insulation. In the case of sound insulation the spacer layer will work as the decoupling layer.

The main flooring part might further comprise an intermediate layer between the aesthetic layer and the spacer layer, and the intermediate layer is at least material connected to the adjacent layers. The intermediate layer might be a film layer or a mass layer and has not only the advantage to optimize the acoustic attenuation of the flooring part, when used in the passenger compartment, it also prevents from any spilled liquid to enter the lower layers and eventually leak underneath the floor part.

The intermediate layer might be an air permeable or impervious film. A single, dual or multi-layer film might be used.

In case of an impervious film, the compressed top layer has preferably an Air Flow resistivity (AFR) of between 500 and 8000 Ns/m3.

In case of a permeable film, the combination of the compressed top layer and of the film together has an AFR of between 500 and 800 Ns/m3, preferably between 1000 and 4000 Ns/m3. Material layers or combinations of material layer with AFR values above 8000 Ns/m3 may be considered acoustically closed. The AFR is measured according to the current version of ISO 9053, using the direct airflow method.

Preferably the intermediate layer, comprises at least one layer comprising at least one of the polymers or copolymers selected from the group consisting of polyester such as polyethylene terephthalate (PET) or polybutylene terephthalate (PBT) or copolyester (CoPES), polyamide such as polyamide 6 or polyamide 66, polyolefin such as a polyethylene (PE) or low density polyethylene (LDPE) or linear low density polyethylene (LLDPE) or high density polyethylene (HDPE), ethylene acrylic acid copolymers (EAA), polypropylene (PP), thermoplastic elastomers (TPEs) such as thermoplastic polyolefin (TPO), thermoplastic polyurethane (TPU), polyetherimide, polysulfone, polyethersulfone, polyetheretherketone and copolymers such as ethylene vinyl acetate (EVA) or biopolymers such as polylactic acid.

The material used is preferably from a recycled source. Advantageously the material of the intermediate layer and the other layers is the same or similar chemical class, enabling a recycling at the end of life of the flooring part. Further increasing the sustainability. However this would also enable the use of cut-offs directly looped back into the production process of the current product.

A main flooring part according to the invention, further comprising at least one local patch covering part of the aesthetic surface, preferably one of a tufted or needle punch floor mat, a rubber patch or a TPO insert, preferably the local patch is placed in a recess in the aesthetic surface. In case of a floor mat type this might be of the shelves solution used in the industry today. However it might also be cut patches that are specifically made for the flooring part, fitting recesses and glued or bonded thereto. Preferably the patches are made or recycled or reclaimed materials. As the main function of these patches is preventing damage due to high abrasion, the materials chosen should have a sufficient level of abrasion performance comparable to carpets and mats according to the state of the art.

Preferably, the aesthetic layer has an area weight of between 250 and 2000 g/m2. Preferably at a thickness of between 2 and 10 mm. As the minimal thickness of the layer is depending on the area weight, lower area weights will be able to obtain lower thickness, while for higher compressed thicknesses more material is needed.

The spacer layer has preferable an area weight of between 500 and 2000 g/m2. The pulled fibers may be the same blends and materials as disclosed for the aesthetic layer. Preferably, the fibers for both layers are the same or similar blend enhancing the recycling at end of life as well as looping back of cut-offs during the production of the part. As the back of the part is directly laid on the vehicle body and will not be visible to the passengers, the colors are not important for this layer.

### Method

Method of producing a flooring part according to one of the preceding claims, with the steps of:
sorting textile waste into different fiber blends and/or colors;
cutting, shredding and pulling the textile waste into fibers;
blending the fibers with a binder in the form of a fiber, or powder;
forming a fibrous mat from the fiber blend using an air lay process or a fiber injection process, optionally the fiber mat may be subjected to a needling step to pre-consolidate the fibrous mat;
molding the fibrous mat to obtain either a 3-dimensionally shaped and consolidated aesthetic surface layer, a spacer layer, and/or a floor part comprising at least an aesthetic surface layer preferably pre-shaped and compressed, and a spacer layer, and whereby during the molding the material is thermally treated to melt the binder and bond the pulled fibers within the felt layer together and to bond the layers to the adjacent layers and to consolidate the material into the final shape of the part.

During the thermal treatment of the aesthetic layer either just before molding or during molding the surface of the aesthetic layer is heat set. The heat setting process works like a surface ironing process. Whereby the outer surface of the aesthetic layer aesthetic to the passenger, when the part is placed in the vehicle is smoothed by heat setting the fibers at the outer most surface of the layer. The heat setting can take place at the heating stage with contact heating in a cold molding process or at the 3D forming tool in hot molding process. Preferably the heat setting process is done with a temperature of at least 110° C. and not more than the softening point of the pulled fibers used for the layer. However higher than the softening point of the binder. This enables the heat set fibers

[symbol]

The method according to claim 11, comprising the additional step of placing a intermediate layer between the aesthetic surface layer and the spacer layer, whereby the intermediate layer is material connected to the adjacent layers after molding.

The heat setting process works like a surface ironing process. Whereby the outer surface of the aesthetic layer aesthetic to the passenger when the part is placed in the vehicle is smooth by heat setting the fibers at the outer most surface of the layer. The heat setting can take place at the heating stage with contact heating before a cold molding process or at the 3D forming tool in a hot molding process. Alternatively a heat setting can be done afterwards with a hot surface against the surface of the aesthetic layer. The heat setting temperature is preferably at least 110° C. and maximal 240° C., preferably between 120° C. and 225° C.

One way of obtaining pulled fibers is by a mechanical process whereby textile waste in the form of discarded garments and clothing can be mechanically processed into recycled pulled fibers. The process of which comprises at least the steps of:
1. Sorting the textile waste into different fiber blends based on the material the clothing is produced with, for instance cotton, polyester, nylon, polypropylene or combinations thereof. Preferably the waste is also separated by color. As the goal is to obtain a sustainable process and product, preferably the fibers will not be treated with a bleaching process or recolored before using in the automotive flooring according to the invention.
2. The fabric is cut and shredded and then pulled apart into fibers.
3. The obtained fibers will be blended with a binder fiber to obtain a moldable blend according to the invention.

The fibers can be processed into a fibrous web by an air-laid process, a fiber injection process or a carding process.

For the main body of the flooring part preferably the air lay process or the fiber injection process may be used. For the insert mat preferably a carding-needling process is chosen.

The different fractions of colors and/or materials might be blended to obtain a preferred aesthetic appearance of the surface of the flooring that is aesthetic to the passengers in the car.

Additional chutes or feeders might be used to feed different color blends onto the fibrous mat creating a color pattern. Alternatively an “additive” textile manufacturing technology, like the 3D-Lofter of DILO® might be used. By featuring a series of individual web forming units masses of fiber may be placed in specific locations on a base web creating a 3D topology. Blends of color fractions might be placed in a pattern creating an aesthetic pleasing surface.

Air lay is a web formation process. Airlaying (air forming) is a method of forming a web by mixing fibers with air to form a uniform air-fiber mixture that is then deposited on a moving air-permeable belt or wire.

Further benefits and advantages of the present invention will become apparent after a careful reading of the detailed description with appropriate reference to the accompanying drawings.

### BRIEF DESCRIPTION OF DRAWINGS

FIG. 1 is an example of a floor part of one embodiment of the present invention.

FIG. 2 is a cross section of FIG. 1.

FIG. 3 shows schematically the method of production of the floor part according to the invention.

### DETAILED DESCRIPTION

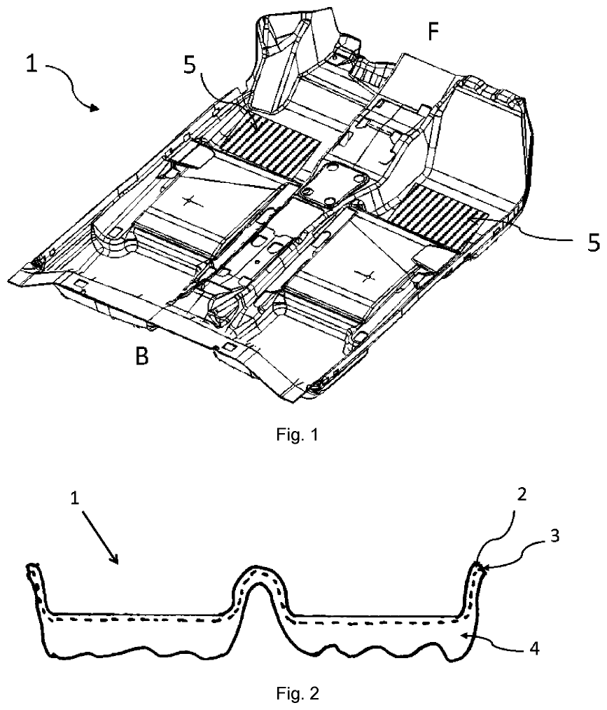

FIG. 1 is showing an example of a floor part 1 according to the invention with F being the direction to the front of the vehicle and B being in the direction of the rear of the vehicle. The full part may be produced with mainly pulled fibers, giving a sustainable product as well as the possibility to recycle again into the same or a similar product. As certain areas in the passenger compartment might be prone to high wear due to scuffing of for instance shoes, it is possible to apply a patch 5 in these areas. Preferably the patch is directly bonded to the surface of the main floor part. Optionally a recess can be formed in the floor part to enable a proper placement of the patch. The patch can also be bonded onto the trim part during or subsequent to the thermal molding process.

FIG. 2 is showing a schematic cross section of the floor part according to the invention. With an aesthetic surface layer 2 and a spacer 4, and optionally a film layer 3 between the aesthetic surface layer and the spacer. The film layer may be an open—for instance perforated—or closed film. In case the film layer is closed it might function together with the compressed top layer as an acoustic insulating flooring part. In case the film is open, the whole part works as a multilayer acoustic trim part. As the carpet layer is no longer necessary the part can be lighter and less complex but also obtains a better acoustic performance as it is no longer unnecessary covered over the full surface.

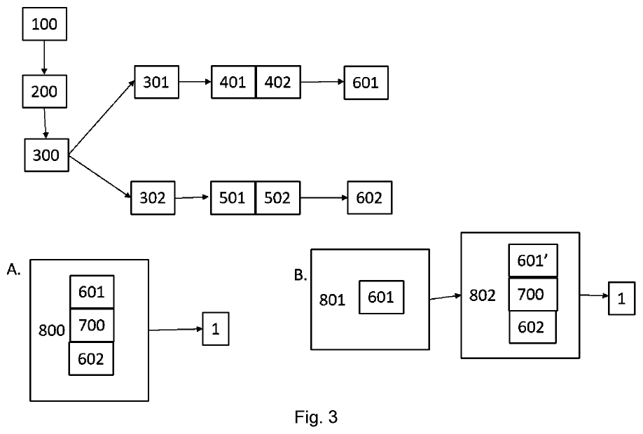

FIG. 3 shows schematically the method of production of the floor part according to the invention.

Method of producing a flooring part according to one of the preceding claims, with the steps of:
sorting textile waste into different fiber material blends and/or colors (100);
cutting, shredding and pulling the textile waste into fibers (200);
blending the fibers with a binder in the form of a fiber, or powder (300) for either the aesthetic layer (301) or the spacer layer (302);

For the aesthetic layer the fiber blend is formed in a web using an air lay process (401) combined with a fiber opening and eventually blending step. For instance on an air lay machine from LaRoche might be used. The thus formed web is instable and a mechanical pre-consolidation step is needed. This is done in the form of a needling step (402), whereby barbed needles are punched from one side through the web, as the barbs are directed away from the surface they will insert smoothly and when pulled out of the web, the barbs will catch single fibers and will displace them into the horizontal direction. Boards on both side of web will help release the mat from the needles. The stroke of the needles will be such that the fibers pulled up will not be sticking out of the surface of the layer. It is not the intention to create a pile type fabric with this step, but only a light consolidation of mat and in addition an initial compaction of the layer.

For the spacer layer a fibrous mat from the fiber blend might be formed (501) by using the same technology as for the aesthetic layer an air lay process, a fiber injection process, for instance using the machine as disclosed in US2014205700, or a vertical lapping process might be used, optionally the fiber mat may be subjected to a light pre-consolidating step (505) for instance a needling step or a thermal consolidating step for instance heated in a hot air oven to pre-consolidate the fibrous mat. As the spacer layer is preferably a low density thick layer, a hot air oven treatment is preferred.

The fibrous mats, the mat for the aesthetic layer (601) and the mat for the spacer layer (602) may be molded in a one step or two step process:

In a one step process (A.) both layers are placed into a mold 800 with an upper mold and a lower mold, which when closed form the flooring part. The intermediate layer 700 is placed between the layers. The molding is done such that pressure is obtained against the lower surface of the top layer such that the aesthetic layer is pressed against the mold and compressed and consolidated in that position, while the spacer layer is not substantially compressed. All layers are consolidated and bonded to the adjacent layer. Surprisingly, the surface of the mold against the surface of the aesthetic layer works as an ironing step whereby the fibers of the surface of the aesthetic surface layer are heat set against the surface of the mold to smooth the aesthetic surface. Preferably the upper mold tool is able to be temperature controlled to optimize the ironing process. The mold is at the end of the step opened and a floor part (1) according to the invention is obtained. Alternatively the ironing step is done after the molding of the part.

Alternatively a two-step process might be used (B.). In this process the fibrous mat for the aesthetic layer is separate molded into a compressed layer (601′), and in an additional step the compressed layer and the spacer layer and eventually the intermediate layer are placed in a mold and the final floor part is formed. While all layers are consolidated and or bonded to the adjacent layers. In this process the ironing of the surface of the aesthetic layer might have been achieved during the initial molding of the layer (801) or during the final molding of the part (802).

Preferably during all molding steps shown the material may be thermally treated to melt the binder and bond the pulled fibers within the felt layer together and to bond the layers to the adjacent layers and to consolidate the material into the final shape of the part. The heat however might be supplied in a pre-heating step for instance with a hot air oven or an infrared heater followed by a cold molding using the heat initially supplied or might be done in a hot molding step supplying the heat directly or indirectly. Preferably steam molding is used for most of the steps, in particularly for the steps of forming the compressed aesthetic layer.

The production might be done in one continuous process or in a discontinuous process, in particularly pre consolidated layers may be produced on another location than the final product.

Optionally in an additional step the patches may be laid and/or bonded to the flooring part. Bonded can be done with a local heating step of the surface containing the adhesive and pressing it to the dedicated area for the patch or patches. Alternative ways of bonding might be used like clipping, velcro or double sided tape. Any glue or adhesive suitable for the bonding might be used, preferably a glue or adhesive on a polyolefin, or polyester base is used.

The patches may be placed directly on the floor part or later after the floor part is placed in the vehicle. In particularly if the patches are just laid on top of the floor part or are bonded by a non-permanent bonding method.

The floor part is defined as either a full part covering the full floor of the vehicle, but it might also include or extent to part or fully side panels, the inner-dash area or the trunk area. The floor part might also be separated in a front flooring part and a rear flooring part, eventually including either the inner-dash or the trunk.

1. A main flooring part for a vehicle comprising:
an aesthetic surface layer;
a spacer layer;
whereby both layers are consolidated and laminated to the adjacent layer to form the flooring part, characterized in that both layers comprise pulled fibers from textile waste and a binder, and whereby the aesthetic surface layer is thermally compressed to form a stiff layer and whereby the fibers of the surface of the aesthetic surface layer are heat set to smooth the aesthetic surface.

2. The main flooring part according to claim 1, wherein the aesthetic surface layer is a thermally compressed needled air lay felt layer.

3. The main flooring part according to claim 1, wherein the spacer layer is either an injected fiber felt layer, a carded cross-lapped, a vertical lapped felt layer or an air lay felt layer.

4. The main flooring part according to claim 1, wherein the pulled fibers are at least for 80% polyester based and/or natural fiber-based, for instance cotton, hemp or flax, and/or cellulose-based and/or a mixture thereof.

5. The main flooring part according to claim 1, wherein the binder is fiber or powder based, preferably from a recycled or reclaimed source, preferably pulled fiber-based.

6. The main flooring part according to claim 1, wherein the binder comprises at least one of a polymer or copolymer chosen from polyester, polyolefin, like polypropylene or polyethylene, or polyamide-based materials.

7. An automotive flooring system according to claim 1, whereby the surface comprises between 20 and 80% by weight, preferably between 40 and 60% by weight of pulled fibers based on cotton and/or polyester, and whereby the binder is between 80 and 20% by weight of polypropylene pulled fibers, with a total amount of fibers and binder of 100% by weight.

8. The main flooring part according to claim 1, further comprising a thermoplastic film layer between the aesthetic layer and the spacer layer and whereby the film layer is at least material connected to the adjacent layers.

9. The main flooring part according to claim 2, wherein the film layer has an air permeability of between 500 and 4000 Rayls.

10. The main flooring part according to claim 2, wherein the film layer comprises at least one layer of a polyester, polyolefin, or polyamide based material, preferably from a recycled source.

11. The main flooring part according to claim 1, further comprising at least one local patch covering part of the aesthetic surface, preferably one of a tufted or needle punch floor mat, a woven fabric, a warp and weft knitted fabric, a rubber patch or a TPO insert, preferably the local patch is placed in recess in the aesthetic surface.

12. A method of producing a flooring part according to claim 1, with the steps of:
sorting textile waste into different fiber blends and/or colors;
cutting, shredding, and pulling the textile waste into fibers;
blending the fibers with a binder in the form of a fiber or powder;
forming a fibrous mat from the fiber blend using an air lay process or a fiber injection process, optionally the fiber mat may be subjected to a needling step to pre-consolidate the fibrous mat;
molding the fibrous mat to obtain either a 3-dimensionally shaped and consolidated aesthetic surface layer, a spacer layer, and/or a floor part comprising at least an aesthetic surface layer, preferably pre-shaped and compressed, and a spacer layer, and whereby during the molding the material is thermally treated to melt the binder and bond the pulled fibers within the felt layer together and to bond the layers to the adjacent layers and to consolidate the material into the final shape of the part and whereby the fibers of the surface of the aesthetic surface layer are heat set against the surface of the mold to smooth the aesthetic surface.

13. The method according to claim 12, comprising the additional step of placing an intermediate layer between the aesthetic surface layer and the spacer layer, whereby the intermediate layer is material connected to the adjacent layers after molding.

14. The method according to one of the claim 12, whereby at least one additional patch made of a tufted or needle punch floor mat, a woven fabric, a warp and weft knitted fabric, a rubber patch, or a TPO insert is bonded or glued or clipped to the dedicated areas on the aesthetic surface of the flooring part.
